(19) United States
(12) Patent Application Publication
(10) Pub. No.: US 2024/0253003 A1
(43) Pub. Date: Aug. 1, 2024

(54) HOLLOW GLASS MICROSPHERES COATED FROM PRISTINE GRAPHENE

(71) Applicant: HydroGraph Clean Power Inc., Toronto (CA)

(72) Inventors: Ranjith Divigalpitiya, London (CA); Jun Wang, London (CA)

(21) Appl. No.: 18/423,954

(22) Filed: Jan. 26, 2024

Related U.S. Application Data
(60) Provisional application No. 63/441,984, filed on Jan. 30, 2023.

(51) Int. Cl. B01J 13/22

(52) U.S. Cl. CPC B01J 13/22

(57) ABSTRACT

Graphene coated hollow glass microspheres may be easily prepared by mixing Pristine Graphene Particles with hollow glass microspheres under conditions to associate the Pristine Graphene Particles on the external surface of the hollow glass microspheres by ionic interaction to form graphene coated hollow glass microspheres. Graphene coated hollow glass microspheres prepared by the methods as described herein are also provided. In an embodiment, graphene coated hollow glass microspheres comprise a graphene coating formed from Pristine Graphene Particles associated on the external surface of the hollow glass microspheres by ionic interaction.

### CROSS-REFERENCE TO RELATED APPLICATIONS

The present application claims the benefit of commonly owned provisional application: Ser. Nos. 63/441,984, filed on Jan. 30, 2023; wherein the entirety of the said provisional application is incorporated herein by reference.

### FIELD

The present invention relates to glass microspheres. More specifically, the present invention relates to coated glass microspheres.

### BACKGROUND

Hollow glass microspheres are used in multiple applications where they are known to impart strength and facture toughness to resin systems incorporating them. Also, since hollow glass microspheres are exceptionally light, they are used as a compositional ingredient for making light-weight composite parts.

US 2021/0230054 describes a method for preparing hollow glass microbeads coated with graphene oxide, which includes: dispersing graphene oxide into deionized water, to form an aqueous graphene oxide solution; placing hollow glass microbeads into the aqueous graphene oxide solution, to achieve a dispersion liquid; and simultaneously performing an ultrasonic vibration treatment and a drying treatment to the dispersion liquid, to achieve the hollow glass microbeads coated with the graphene oxide. Other methods of coating hollow glass microbeads are described in the Background section as well.

Graphene coated light hollow bead particles and a method of preparing same are described in CN110423017A. In the method, light hollow microbead particles are coated with graphene by a CVD method.

### SUMMARY

It has been discovered that unique graphene coated hollow glass microspheres may be easily prepared by mixing Pristine Graphene Particles with hollow glass microspheres under conditions to associate the Pristine Graphene Particles on the external surface of the hollow glass microspheres by ionic interaction to form graphene coated hollow glass microspheres.

For purposes of the present disclosure, Pristine Graphene Particles are graphene particles produced by the controlled detonation of a reaction mixture comprising a carbon-containing material to form highly ordered graphene particles having a carbon content of at least about 98.5%, an oxygen content of less than 1% and comprising less than 0.5% of non-carbon or non-oxygen foreign substances and impurities.

Pristine Graphene Particles thus are carbon particles having morphology and characteristics of graphene with high purity, in contrast with, for example, conventional graphene oxide or graphitic soot. Pristine Graphene Particles may be provided in the form of primary particles and/or aggregate particles, which are aggregations of primary particles. In an embodiment, the primary particles of Pristine Graphene Particles initially produced in the controlled detonation have an average longest dimension of from about 5 nm to 50 nm. In an embodiment, the primary particles of Pristine Graphene Particles are the form of flakes having an average thickness of from about 0.3 nm to about 2 nm thick. After the detonation reaction, the primary particles are initially dispersed within the reaction vessel in the form of an aerosol.

In an embodiment, the primary particles of Pristine Graphene Particles are allowed to aggregate to form aggregate particles that may be present in various morphologies. Examples of such aggregation morphologies include ramified fractal aggregates, nanosheets, crystalline flakes, nanoplatelets and platelet chains, and multilayer graphene flakes.

In an embodiment, the Pristine Graphene Particles comprise aggregate particles that are aggregated graphene flakes having an average longest dimension of from about 35 nm to about 500 nm.

In an embodiment, the Pristine Graphene Particles used in preparation of the graphene coated hollow glass microspheres (i.e. including both non-aggregated primary particles and aggregate particles) have an average particle size of from about 10 to about 500 nm.

It has been discovered that the high purity and small particle size of the Pristine Graphene Particles produced by the controlled detonation may advantageously be readily dispersed in a solution and mixed with hollow glass microspheres under conditions to associate the Pristine Graphene Particles on the external surface of the hollow glass microspheres by ionic interaction to form graphene coated hollow glass microspheres that exhibit excellent properties.

In an embodiment, the coating formed on the hollow glass microspheres with the Pristine Graphene Particles provides a non-uniform coating covering at least about 60% of the external surface area of the hollow glass microspheres when evaluated by field emission scanning electron microscope (“FESEM”) at 250× magnification.

In an embodiment, the coating formed on the hollow glass microspheres with the Pristine Graphene Particles covers over at least about 60% of the external surface area of 90% of the hollow glass microspheres when evaluated by FESEM at 250× magnification. In an embodiment, the coating formed on the hollow glass microspheres with the Pristine Graphene Particles covers over at least about 70% of the external surface area of 90% of the hollow glass microspheres when evaluated by FESEM at 250× magnification. In an embodiment, the coating formed on the hollow glass microspheres with the Pristine Graphene Particles is covers over at least about 80% of the external surface area of 90% of the hollow glass microspheres when evaluated by FESEM at 250× magnification.

In an embodiment, graphene coated hollow glass microspheres comprise hollow glass microspheres having an average diameter of from about 10 μm to 150 μm and a wall thickness of from about 0.5 μm to about 2 μm, and Pristine Graphene Particles having an average particle size of from about 10 to about 500 nm. The Pristine Graphene Particles are associated on the external surface of the hollow glass microspheres by ionic interaction.

It has been found that graphene coated hollow glass microspheres as described herein may be advantageously used as additives in compositions, such as resin based systems, to impart advantageous physical properties such as tensile strength, compressive strength, and fracture toughness.

In an embodiment, the present graphene coated hollow glass microspheres advantageously can be used as a component in composite parts, where the part has a reduced weight as compared to like parts that do not contain hollow glass microspheres.

In an embodiment, the graphene coated hollow glass microspheres as described herein may be advantageously used to provide an alternative, environmentally friendly, stable, black color component. In an embodiment, the resulting parts comprising the present graphene coated hollow glass microspheres can impart a black or grey color to the part due to the apparent color of the black color present graphene coated hollow glass microspheres.

In an embodiment, the graphene coated hollow glass microspheres as described herein may be advantageously used to provide an electrically conductive gel or resin materials. In an embodiment, the electrically conductive material comprising the graphene coated hollow glass microspheres as described herein may be in the form of a liquid, semi-solid or solid material.

In an embodiment, manufactured parts comprising the present graphene coated hollow glass microspheres can exhibit improved electrical conductivity as compared to like parts that do not contain the present graphene coated hollow glass microspheres.

It has been found that use of the graphene coated hollow glass microspheres as described herein in, for example, a resin significantly lowers the percolation threshold as compared to directly mixing graphene into a resin. Thus, it will be advantageous to use graphene coated microspheres instead of using graphene directly in composite applications where either electrical conductivity or compressive strength is to be enhanced. Compositions comprising the graphene coated hollow glass microspheres as described herein may therefore advantageously provide excellent static dissipative effects.

In an embodiment, the graphene coated hollow glass microspheres as described herein may be advantageously used to provide a thermally conductive gel or resin materials. In an embodiment, the thermally conductive material comprising the graphene coated hollow glass microspheres as described herein may be in the form of a liquid, semi-solid or solid material. Compositions comprising the graphene coated hollow glass microspheres as described herein may therefore advantageously may exhibit excellent thermal conductive properties, and be highly effective to dissipate heat in environments as needed, such as in electronic packaging and semiconductor chips.

It additionally has been found the graphene coated hollow glass microspheres as described herein tend to exhibit excellent flow properties, behaving as free-flowing powder without the need to include flow aid additives. The graphene coated hollow glass microspheres as described herein have been found to facilitate easy mixing in intermediate compositions. While not being bound by theory, it is believed that the location of the Pristine Graphene Particles on the external surface of the hollow glass microspheres provides a low-friction external surface that facilitates mixing.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a photograph of jars of uncoated hollow glass microspheres and graphene coated hollow glass microspheres.

FIG. 2 is an FESEM image of graphene coated hollow glass microspheres, where the image was collected at 250× magnification.

FIG. 3 is an FESEM image of a different view of graphene coated hollow glass microspheres, where the image was collected at 250× magnification.

FIG. 4 is an enhanced view of the FESEM image of FIG. 2, where the image was collected at 500× magnification.

FIG. 5 is an enhanced view of the FESEM image of FIG. 4, where the image was collected at 1500× magnification.

FIG. 6 is an enhanced view of the FESEM image of FIG. 5, where the image was collected at 3500× magnification.

FIG. 7 is an enhanced view of the FESEM image of FIG. 6, where the image was collected at 20,000× magnification.

FIG. 8 is an FESEM image of a different view of graphene coated hollow glass microspheres, where the image was collected at 500× magnification.

FIG. 9 is an enhanced view of the FESEM image of FIG. 8, where the image was collected at 1500× magnification.

FIG. 10 is an enhanced view of the FESEM image of FIG. 9, where the image was collected at 3500× magnification.

FIG. 11 is an enhanced view of the FESEM image of FIG. 10, where the image was collected at 20,000× magnification.

### DETAILED DESCRIPTION

The embodiments of the present invention described below are not intended to be exhaustive or to limit the invention to the precise forms disclosed in the following detailed description. Rather a purpose of the embodiments chosen and described is by way of illustration or example, so that the appreciation and understanding by others skilled in the art of the general principles and practices of the present invention can be facilitated.

In the present method, Pristine Graphene Particles are mixed with hollow glass microspheres under conditions to associate the Pristine Graphene Particles on the external surface of the hollow glass microspheres by ionic interaction to form graphene coated hollow glass microspheres.

The hollow glass microspheres used as described herein may be prepared from any suitable glass composition, such as soda lime silica glass, borosilicate glass, or barium titanate glass. Hollow glass microspheres may be commercially obtained, for example, from 3M, St. Paul, MN, or Cospheric LLC, Santa Barbara, CA. In general, hollow glass microspheres are used in many applications due to their lightness and thermally insulating properties. The spherical glass envelope trapping air inside it provides thermal insulating properties and acts as a low density component for many uses.

In an embodiment, the hollow glass microspheres have an average diameter of from about 10 μm to about 150 μm and a wall thickness of from about 0.5 μm to about 2 μm. In an embodiment, the hollow glass microspheres have an average diameter of from about 20 μm to 140 μm. In an embodiment, the hollow glass microspheres have an average diameter of from about 30 μm to about 115 μm. In an embodiment, the hollow glass microspheres have an average diameter of from 30 μm to 90 microns. In an embodiment, the hollow glass microspheres have an average diameter of from about 15 μm to about 70 μm. In an embodiment, the hollow glass microspheres have an average diameter of from about 10 μm to 50 μm.

In an embodiment, the hollow glass microspheres have a wall thickness of from about 0.7 μm to about 1.2 μm.

While some commercially available varieties of hollow glass microspheres can withstand very high static pressure due to the strength of glass and the spherical shape; the wall thickness of the spheres is an important factor of the isostatic crush strength of these particles. It has been found that the graphene coated hollow glass microspheres as described herein exhibit excellent strength that exceeds expectations based on the size and wall thickness of the glass alone.

While not being bound by theory, it is believed that coating of hollow glass microspheres as described herein provides an advantageous lubrication effect that reduces forces imparted to microspheres, providing improved resistance to breakage during mixing.

In an embodiment, the hollow glass microspheres are treated to provide a negative charge on the external surface of the glass microspheres. In an embodiment, the hollow glass microspheres are treated to provide a hydroxyl functionality on the external surface of the glass microspheres.

In an embodiment, the hollow glass microspheres are treated in a solution having a pH greater than 7 prior to mixing with the Pristine Graphene Particles to provide a negative charge on the external surface of the glass microspheres, so that the positively charged Pristine Graphene Particles are associated on the external surface of the hollow glass microspheres by ionic interaction. In an embodiment, the hollow glass microspheres are treated in a solution having a pH greater than 8 prior to mixing with the Pristine Graphene Particles to provide a negative charge on the external surface of the glass microspheres. In an embodiment, the hollow glass microspheres are treated in a solution having a pH greater than 9 prior to mixing with the Pristine Graphene Particles to provide a negative charge on the external surface of the glass microspheres. In an embodiment, the hollow glass microspheres are treated in a solution having a pH greater than 10 prior to mixing with the Pristine Graphene Particles to provide a negative charge on the external surface of the glass microspheres. In an embodiment, the hollow glass microspheres are treated in a solution having a pH greater than 11 prior to mixing with the Pristine Graphene Particles to provide a negative charge on the external surface of the glass microspheres. In an embodiment, the hollow glass microspheres are treated in a solution having a pH greater than 12 prior to mixing with the Pristine Graphene Particles to provide a negative charge on the external surface of the glass microspheres.

In an embodiment, the hollow glass microspheres are treated in a solution comprising a base selected from the group consisting of KOH, NaOH, NH₄OH, and combinations thereof.

While not being bound by theory, it is believed that treatment of the hollow glass microspheres with certain alkaline agents may etch the external surface of the hollow glass microspheres, thereby thinning the walls of the microspheres. The resulting treated hollow glass microspheres are therefore lighter, which is advantageous in light-weighting applications. At the same time, the external surface of the graphene coated hollow glass microspheres exhibits low friction properties, reducing the likelihood that the hollow glass microspheres will break when exposed to certain friction inducing conditions. This combination of effects provides a surprisingly robust, light weight hollow glass microsphere product.

As noted above, Pristine Graphene Particles are graphene particles produced by the controlled detonation of a reaction mixture, the particles having morphology and characteristics of graphene with high purity. The Pristine Graphene Particles have a carbon content of at least about 98.5%, an oxygen content of less than 1% and comprising less than 0.5% of non-carbon or non-oxygen foreign substances and impurities. In an embodiment, the Pristine Graphene Particles have a carbon content of at least about 99.4%, an oxygen content of less than 0.1% and comprise less than 0.5% of non-carbon or non-oxygen foreign substances and impurities.

The Pristine Graphene Particles used in preparation of the graphene coated hollow glass microspheres (i.e. including both non-aggregated primary particles and aggregate particles) have an average particle size of from about 10 to about 500 nm. In an embodiment, the Pristine Graphene Particles used in preparation of the graphene coated hollow glass microspheres have an average particle size of from about 35 nm to about 250 nm. In an embodiment, the Pristine Graphene Particles used in preparation of the graphene coated hollow glass microspheres have an average particle size of from about 50 nm to about 200 nm. In an embodiment, the Pristine Graphene Particles used in preparation of the graphene coated hollow glass microspheres have an average particle size of from about 75 nm to about 150 nm.

Pristine Graphene Particles may be prepared, for example, by disposing a mixture comprising a combustible carbon-containing material and an oxidizing agent for the carbon-containing material in an enclosed vessel and detonating the mixture within the vessel. The heat produced by the detonation causes a temperature of at least 3000 K so as to generate graphene particles. The graphene particles are then recovered from the vessel.

In another embodiment, A mixture comprising a C1-C12 hydrocarbon compound and oxygen is provided within an enclosed vessel. The mixture is detonated within the vessel. The heat produced by the detonation causes a temperature of at least 3000 K thereby producing an aerosol comprising graphene nanosheets. The graphene nanosheets are removed from the vessel prior to aggregation of the nanosheets into a carbon gel. In another embodiment, the mixture comprising a combustible carbon-containing material and an oxidizing agent for the carbon-containing material is provided within an enclosed vessel. The mixture is detonated within the vessel so as to generate graphene particles. The graphene particles are recovered from the vessel prior to aggregation of the graphene particles into a carbon gel.

These non-aggregated graphene flakes may tend to aggregate immediately upon formation into particles having an average size of between about 10 to about 500 nm, between about 35 to about 250 nm, between about 50 to about 200 nm, or between about 75 to about 150 nm.

In an embodiment, the Pristine Graphene Particles comprise graphene flakes having an average number of from 3 to 9 graphene layers.

Preparation of fractal graphene particles, and in particular fractal graphene particles, is described in U.S. Pat. No. 9,440,857 and WO 2020/257229, the disclosures of which are incorporated by reference herein.

In an embodiment, Pristine Graphene Particles, if permitted, will form relatively large aggregate particle structures and even aggregate to a degree sufficient to form a gel. If the graphene particles aggregate to form fractal graphene particles that are larger than desired (including aggregation to a sufficiently large extent to form a gel), the aggregated Pristine Graphene Particles may be milled or otherwise processed to reduce the size of the fractal graphene particles to the size appropriate for association with the hollow glass microspheres as described herein. In an embodiment, the aggregated Pristine Graphene Particles will disassociate from each other when put in a solution for mixing with the hollow glass microspheres. In particular, it has been found that aggregated Pristine Graphene Particles will disassociate from each other when put in a solution comprising a surfactant, such as discussed below.

Graphene Particles produced by the controlled detonation of a reaction mixture comprising a carbon-containing material are unique materials that differ substantially from graphene oxide materials prepared using “classical approaches” to preparing different graphene oxide material (referred to herein as “Classic Graphene Oxide” or “Classic GO”) is described in WO 2020/257229 to Bossmann, et. al. (“WO '229”), the disclosure of which is incorporated by reference herein in its entirety.

As explained in WO '229, Classic GO is prepared, for example, by oxidizing graphite using strong oxidizers and harsh chemical reaction conditions to form graphite oxide, which then undergoes exfoliation and further oxidation to graphene oxide. Alternative approaches to synthesizing GO also reported in WO '229 include synthesis of graphene oxide nanosheets (GON) on external surfaces via hydrothermal polymerization of glucose, followed by thermal annealing at 1300 K on quartz wafers and oxidized epitaxial graphene on SiC(0001) using atomic oxygen in ultra-high vacuum. The processes used to prepare Classic GO introduce oxidized functionalities throughout the resulting graphene oxide, and the final product consequently has an oxygen content that is generally greater than 40 wt %.

An unusual character of pristine graphene particles is their external surface charge is positive. The measured zeta potential of pristine graphene particles has been shown to be +60 mV. While not being bound by theory, it is believed that low density of carbocations in the pristine graphene particles' structure is responsible for the positive charges. Since the external surface charge of the pristine graphene particles is already positive, in an embodiment no pretreatment is necessary to attain association of the Pristine Graphene Particles on the external surface of the hollow glass microspheres by ionic interaction to form graphene coated hollow glass microspheres.

In an embodiment, the Pristine Graphene Particles may be provided in a solution comprising a surfactant. In an embodiment, it has been found that incorporation of a surfactant with the Pristine Graphene Particles facilitates distribution of the Pristine Graphene Particles in the solution. In an embodiment it has been found that incorporation of a surfactant in the process facilitates mixing of the Pristine Graphene Particles with the hollow glass microspheres. In an embodiment, the surfactant is selected from the group consisting of sodium cholate and hexadecyltrimethylammonium bromide (“CTAB”).

In an embodiment, it has been found that incorporation of a surfactant with the Pristine Graphene Particles results in an enhanced coating effect of the Pristine Graphene Particles on the external surface of the hollow glass microspheres. It believed that the use of surfactant in the process increases the thickness of graphene material on the external surface of the hollow glass microspheres.

It has been found that use of a surfactant in preparation of the graphene coated hollow glass microspheres facilitates association of the graphene particles to the glass external surface, resulting in an observable improvement in the color of the graphene coated hollow glass microspheres. For example, in embodiments where no surfactant is employed, the final graphene coated hollow glass microspheres may have an appearance that is a variation of grey in color, while embodiments where surfactant is employed, the final graphene coated hollow glass microspheres may have superior association of graphene on hollow glass microspheres, resulting in graphene coated hollow glass microspheres having a distinctly black appearance. Likewise, graphene coated hollow glass microspheres prepared by a process including use of surfactant exhibit superior electrical conductivity characteristics as compared to graphene coated hollow glass microspheres prepared by a process that does not include use of surfactant.

While not being bound by theory, it is believed that charges associated with the surfactant provide an enhanced charge effect and/or charge distribution effect to the Pristine Graphene Particles, so that more particles associate with the hollow glass microspheres.

In an embodiment, the Pristine Graphene Particles are treated with a surfactant prior to mixing of the Pristine Graphene Particles with the hollow glass microspheres. In an embodiment, the Pristine Graphene Particles are treated with a surfactant at the time of mixing of the Pristine Graphene Particles with the hollow glass microspheres.

In an embodiment, the Pristine Graphene Particles are mixed with the hollow glass microspheres at a temperature of less than about 40° C. In an embodiment, the Pristine Graphene Particles are mixed with the hollow glass microspheres at a temperature of less than about 35° C. In an embodiment, the Pristine Graphene Particles are mixed with the hollow glass microspheres at a temperature of less than about 30° C. In an embodiment, the Pristine Graphene Particles are mixed with the hollow glass microspheres at a temperature of from about 10° C. to about 40° C. In an embodiment, the Pristine Graphene Particles are mixed with the hollow glass microspheres at a temperature of from about 10° C. to about 35° C. In an embodiment, the Pristine Graphene Particles are mixed with the hollow glass microspheres at a temperature of from about 10° C. to about 30° C.

In an embodiment, the Pristine Graphene Particles are mixed with the hollow glass microspheres under gentle stirring conditions such that less than 30% of the hollow glass microspheres are broken during the preparation of the graphene coated hollow glass microspheres. In an embodiment, the Pristine Graphene Particles are mixed with the hollow glass microspheres under gentle stirring conditions such that less than 20% of the hollow glass microspheres are broken during the preparation of the graphene coated hollow glass microspheres. In an embodiment, the Pristine Graphene Particles are mixed with the hollow glass microspheres under gentle stirring conditions such that less than 10% of the hollow glass microspheres are broken during the preparation of the graphene coated hollow glass microspheres.

In an embodiment, the graphene coated hollow glass microspheres are further processed to break up any agglomerates present after drying. In an embodiment, the graphene coated hollow glass microspheres are further processed with a rotary polishing machine either with a soft polishing media such as polymer spheres or bulk glass spheres whose densities are very different from coated microspheres. This can be done with a laboratory roll mill, for example. The polishing can be done with or without any extra media; in the latter case the coated Hollow Glass Microspheres themselves will act as polishing medium as well as the substrate. The roll milling can break up any agglomerates present after drying, and also remove some of the debris present on the surface of the bubbles to create a smoother finish. Use of added polishing media may facilitate separation of the final product graphene coated hollow glass microspheres from materials other materials present in the composition including the polishing media. An example of dry separable polishing media would be magnetic toner particles which can be removed from Hollow Glass Microspheres using a magnetic field. Other polishing media may be separated from the final product graphene coated hollow glass microspheres by floatation and drying.

The effective degree of coating and the nature of the coating of graphene on the hollow glass microspheres can be evaluated by study of FESEM at 250× magnification.

In an embodiment, the graphene coated hollow glass microspheres have an average graphene coating coverage of at least about 60% of the external surface area of the hollow glass microspheres when evaluated by FESEM at 250× magnification.

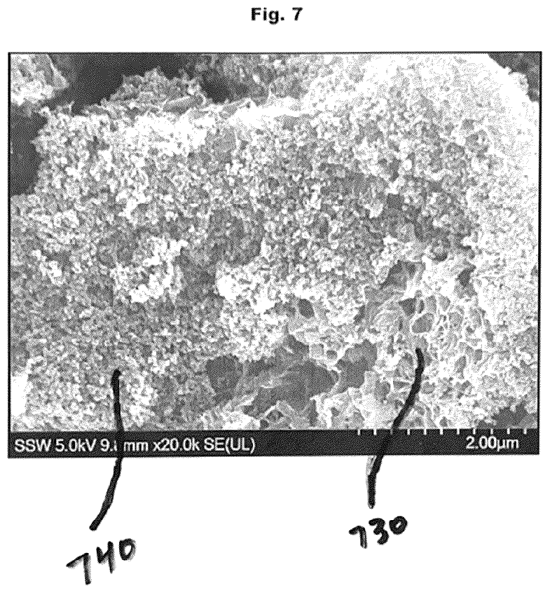

On close inspection when evaluated by FESEM at 200000× magnification, it is noted that at least a portion of the graphene coating on the external surface of the hollow glass microspheres may have a “smeared coating” appearance that is different from the appearance of identifiable Pristine Graphene Particles per se. See. E.g. FIG. 7 as discussed below. In some embodiments, this smeared coating may be a continuous coating, and in some embodiments, this smeared coating may be a continuous or discontinuous having an irregular external surface texture. In some embodiments, this smeared coating may additionally comprise separately identifiable Pristine Graphene Particles associated on top of the smeared coating and/or associated directly to the hollow glass microspheres without an intervening smeared coating.

While not being bound by theory, it is believed that the “smeared coating” is generated by some modification of the Pristine Graphene Particles during the coating process to fuse the Pristine Graphene Particles into what appears to be a continuous coating layer over at least some external surface regions of the microspheres. It is noted that some intact Pristine Graphene Particles may remain that are associated by ionic interaction as substantially unmodified particles on the external surface of the hollow glass microspheres.

In an embodiment, the Pristine Graphene Particles are present on the hollow glass microspheres in an amount effective to provide graphene coated hollow glass microspheres having an electrical conductivity of from about 0.4 S/m to about 0.6 S/m.

Conventional hollow glass microspheres have the appearance of a white powder to the naked eye. In an aspect, conventional hollow glass microspheres have an L*a*b*color value prior to coating of L*=92.3; a*=0.02 & b*=−0.68. However, it has surprisingly been found that by providing graphene coated hollow glass microspheres as described herein, hollow glass microspheres can be provided that exhibit a black appearance. This color appearance is surprisingly effective in changing the appearance of compositions containing the graphene coated hollow glass microspheres as described herein. In an embodiment, the Pristine Graphene Particles are present on the hollow glass microspheres in an amount effective to provide graphene coated hollow glass microspheres having an L*a*b*color value of L*=about 15 to 17; a*=about −1 to 0; and b*=about −0.5 to −1.5. In an embodiment, the Pristine Graphene Particles are present on the hollow glass microspheres in an amount effective to provide graphene coated hollow glass microspheres having an L*a*b*color value of about L*=16.6; a*=−0.43 & b*=−0.98.

The graphene coated hollow glass microspheres prepared by the methods as described herein and having the characteristics as described herein are unique and advantageous.

### EXAMPLES

### Analysis Methods

Coatings of graphene coated hollow glass microspheres were evaluated by examination of images obtained using field emission scanning electron microscope (“FESEM”) scans. The images shown herein were prepared using a Hitachi SU8230 Regulus ultra-high-resolution FESEM. A 5 kV accelerating voltage was used and the samples were tilted 30°. The microsphere samples were mounted in carbon paint, and all samples were coated with 5 nm of chromium to minimize sample charging artifacts. A series of images were collected at 250×, 500×, 1,500×3,500× and 20,000× magnification.

Evaluation of the average graphene coating coverage of at least about 60% of the external surface area of the hollow glass microspheres can be carried out by image processing software such as IMAGEJ or other suit able image analysis techniques.

### Example 1: Hydroxylation of Hollow Glass Microspheres

Hollow glass microspheres obtained from 3M (“3M™ Glass Bubbles K20”) were hydroxylated as follows:
1. Dispense about 20 g of glass microspheres into a 500 ml beaker
2. Add adequate DI water and mix the glass microsphere suspension for 15 minutes using the magnetic stirrer
3. Allow the mixture to stand for 2 h
4. Withdraw glass microspheres floating in the beaker
5. Dissolve 8.84 g KOH in 300 ml DI water
6. Add the glass microspheres withdrawn in step 4 to the KOH solution and mix with heating at 80° C. for 1.5 h. Heating is carried out using a reflux setup
7. Vacuum filter the treated glass microspheres and rinse using DI water until pH is a constant
8. Dry the treated glass microspheres on a hot plate at 90° C. for 2 hours.
9. Store the treated glass microspheres in a vacuum desiccator.

As a comparison, the hollow glass microspheres were instead treated with nitric acid instead of potassium hydroxide. The resulting hollow glass microspheres had a positive external surface charge. Results of attempts to use these acid-treated hollow glass microspheres are reported below.

### Example 2: Preparation of Pristine Graphene Particles Surfactant Solution

Pristine Graphene Particles produced by the controlled detonation of a reaction mixture as described above are added to water comprising sodium cholate (cholic acid sodium salt, or “CASS”) surfactant to form a suspension of graphene in water as follows:
1. 2 g of CASS are dissolved in 1 L of DI water
2. Weigh and add 1.005 g of Pristine Graphene Particles to a centrifuge bottle
3. 200 ml of the CASS solution is added to the centrifuge bottle
4. The resulting particle/CASS mixture is ultrasonicated for 15 min
5. The ultrasonicated particle/CASS mixture is centrifuged at 7000 rpm at 23° C. for 5 min
6. the supernatant is transferred to the storage bottle, and the precipitate is permitted to remain in the centrifuge bottle
7. 200 ml of the CASS solution is added to the centrifuge bottle
8. steps 4 to 7 several times are repeated until all the Pristine Graphene Particles are dispersed in CASS solution

The concentration of the Pristine Graphene Particles in the dispersion is reported as g Particles/ml CASS solution

### Example 3: Graphene Coating of Hollow Glass Microspheres

1. 50 ml of Pristine Graphene Particles/CASS dispersion is deposited in 250 ml flask using 50 ml pipette
2. 25 ml DI water is added to the flask (or add 25 ml 0.2 g/ml KOH solution)
3. the dispersion and DI water (KOH Solution) are mixed for 10 min
4. about 4 g of the pre-treated Hollow Glass Microspheres are added to the flask
5. the suspension is mixed at 700 rpm at room temperature for 14 h
6. The excess PRISTINE GRAPHENE PARTICLES/CASS dispersion is removed by vacuum filtration (if KOH solution is used in step 2, the coated Hollow Glass Microspheres are rinsed until the pH of supernatant is constant)
7. The coated Hollow Glass Microspheres are dried on an 80° C. hot plate for 1 hour
8. the coated Hollow Glass Microspheres are stored in a vacuum desiccator

Characteristics of coated Hollow Glass Microspheres obtained are reported in Tables 1 and 2 below:

TABLE 1
Coatings obtained on Hollow Glass Microspheres treated with base and acid

| | External | | External | | |
|---|---|---|---|---|---|
| Treatment of | surface Charge | Treatment | surface | | |
| Hollow Glass | on Hollow Glass | of Graphene | Charge on | Coating | Coating |
| Microspheres | Microspheres | Aerosol Gel | graphene | Observed | Quality |
| Base (KOH) | −ve | Pristine Graphene | +ve | Yes | Thick black |
| treated | | Particles dispersed | | | coating |
| (hydroxylation) | | in water with | | | |
| | | surfactant | | | |
| In dl water with | +ve | Pristine Graphene | +ve | No | — |
| acid (HNO₃) | | Particles | | | |
| | | in water with | | | |
| | | surfactant | | | |

TABLE 2
Properties of Uncoated and Coated Hollow Glass Microspheres.

| | 3M K20 HOLLOW GLASS | Graphene coated HOLLOW |
|---|---|---|
| | MICROSPHERES | GLASS MICROSPHERES |
| Appearance | Free-flowing white powder | Free-flowing black powder |
| Tap Density | 121.8 ± 0.1 | 79.6 ± 3.9 |
| (mg/c.c.) | | |
| Electrical | Insulating | conductive |
| conductivity | | 0.4 to 0.6 S/m |
| (S/m) | | |
| Color (CIE) | L* = 92.30; a* = 0.02; | L* = 16.62; a* = −0.43; |
| | b* = −0.68 | b* = −0.98 |

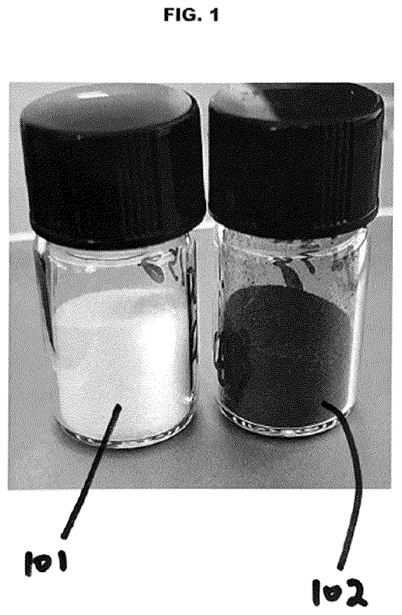

FIG. 1 is a photograph of jars of white colored uncoated hollow glass microspheres 101 and black colored graphene coated hollow glass microspheres 102.

### Observations:

Flow properties of graphene coated hollow glass microspheres were not significantly altered as determined by visual comparison of simple shaking of vials containing the Uncoated and Graphene Coated Hollow Glass Microspheres, respectively.

The measured tap density of the Graphene Coated Hollow Glass Microspheres was surprisingly and significantly less than that of the original microspheres. This is understood in terms of hydroxylation reaction where KOH has likely etched the bubble external surface thus reducing the wall thickness before coating. Prolonged alkali treatment and stirring with a magnetic stirrer was observed to damage the microsphere external surfaces. It may be useful to use a less corrosive alkali for hydroxylation reaction. Damage of the microspheres was avoided by shaking the mixture in a mechanical shaker, i.e. gentle shaking. Lower density, as disclosed here to be about 30% less than original fillers, was surprising but very advantageous in terms of use in light weighting applications.

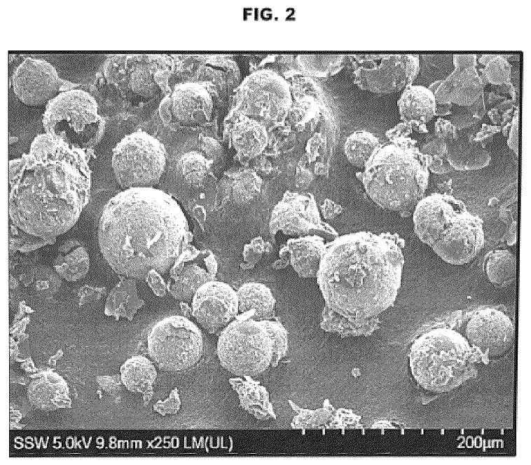

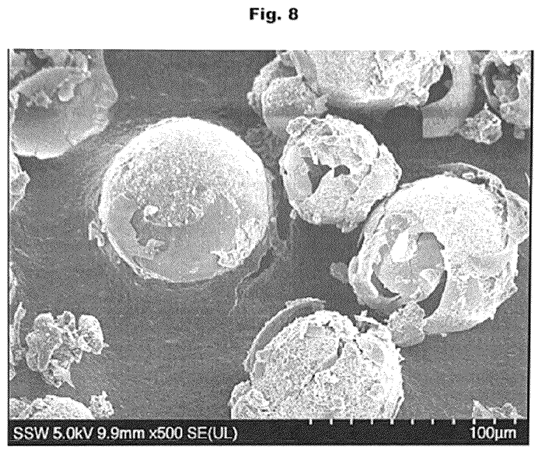

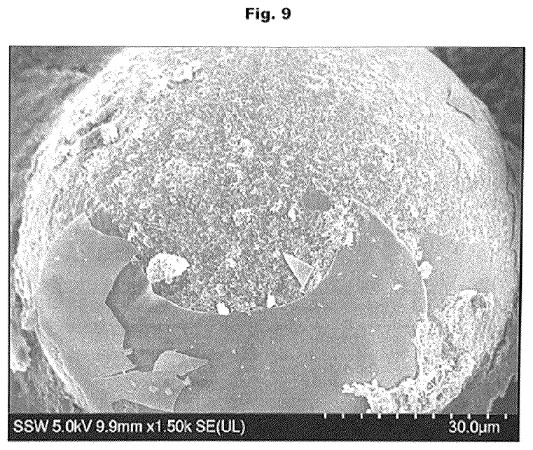

FESEM images of the graphene coated hollow glass microspheres were collected at 250×, 500×, 1,500×3,500× and 20,000× magnification, as shown in FIGS. 2-11.

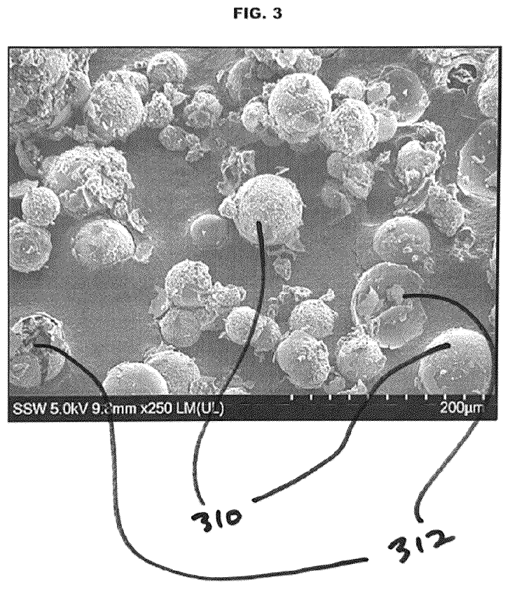

FIG. 3 is an FESEM image of a different view of graphene coated hollow glass microspheres, where the image was collected at 250× magnification. Intact capsules 310 and broken microspheres 312 can be observed in the image.

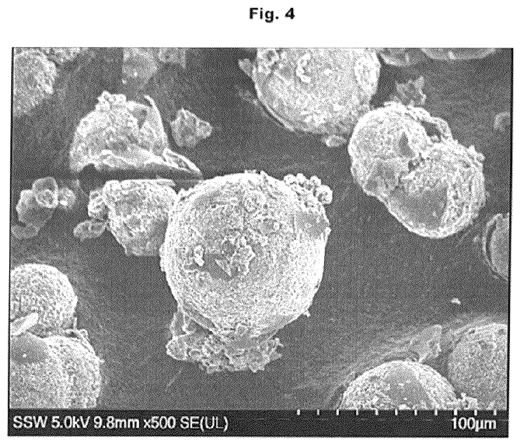

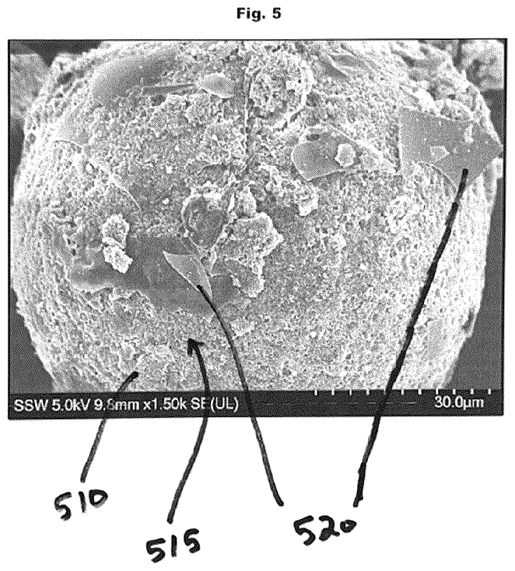

FIG. 5 is an enhanced view of the FESEM image of FIG. 4, where the image was collected at 1500× magnification. Smaller pieces/shards of broken microspheres 520 can be seen on the coated surface 515 of the intact microsphere 510.

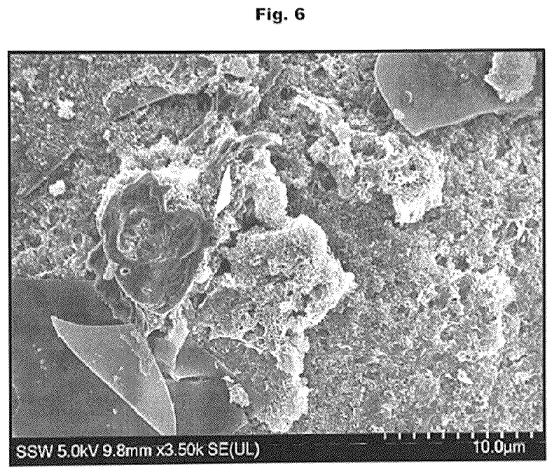

FIG. 7 is an enhanced view of the FESEM image of FIG. 6, where the image was collected at 20,000× magnification. A portion of the graphene coating on the external surface of the hollow glass microsphere has a “smeared coating” appearance 730 that as shown appears to be discontinuous and having an irregular external surface texture. Separately identifiable Pristine Graphene Particles 740 are associated on top of the smeared coating and/or associated directly to the hollow glass microspheres without an intervening smeared coating.

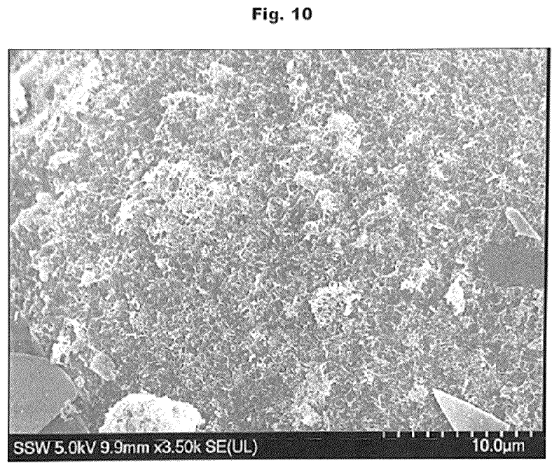

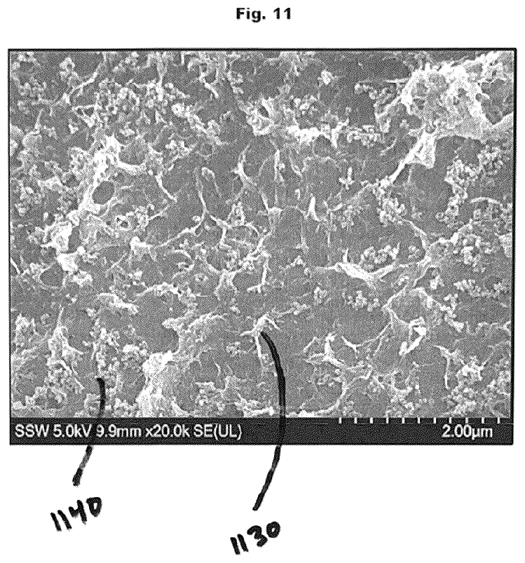

FIG. 11 is an enhanced view of the FESEM image of FIG. 10, where the image was collected at 20,000× magnification. FIG. 11 provides a close view of the external surface of the hollow glass microsphere having a “smeared coating” appearance 1130 that as shown appears to be discontinuous and having an irregular external surface texture. Separately identifiable Pristine Graphene Particles 1140 are associated on top of the smeared coating.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of making graphene coated hollow glass microspheres comprising:
providing Pristine Graphene Particles having an average particle size of from about 10 to about 500 nm;
providing hollow glass microspheres having an average diameter of from about 10 μm to about 150 μm and a wall thickness of from about 0.5 μm to about 2 μm and having an external surface; and
mixing the Pristine Graphene Particles with the hollow glass microspheres under conditions to associate the Pristine Graphene Particles on the external surface of the hollow glass microspheres by ionic interaction to form graphene coated hollow glass microspheres.

2. The method of claim 1, wherein the hollow glass microspheres have an average diameter of from about 20 μm to 140 μm, or wherein the hollow glass microspheres have an average diameter of from about 20 μm to 140 μm, or wherein the hollow glass microspheres have an average diameter of from about 30 μm to about 115, or wherein the hollow glass microspheres have an average diameter of from 30 μm to 90 μm, or wherein the hollow glass microspheres have an average diameter of from about 15 μm to about 70 μm, or wherein the hollow glass microspheres have an average diameter of from about 10 μm to 50 μm.

3. The method of claim 1, wherein the hollow glass microspheres have a wall thickness of from about 0.7 μm to about 1.2 μm.

4. The method of claim 1, wherein the hollow glass microspheres are treated the hollow glass microspheres are treated to provide a negative charge on the external surface of the glass microspheres; or wherein the hollow glass microspheres are treated to provide a hydroxyl functionality on the external surface of the glass microspheres.

5. The method of claim 1, wherein the hollow glass microspheres are treated in a solution having a pH greater than 7 prior to mixing with the Pristine Graphene Particles to provide a negative charge on the external surface of the glass microspheres; or wherein the hollow glass microspheres are treated in a solution having a pH greater than 8 prior to mixing with the Pristine Graphene Particles to provide a negative charge on the external surface of the glass microspheres; or wherein the hollow glass microspheres are treated in a solution having a pH greater than 9 prior to mixing with the Pristine Graphene Particles to provide a negative charge on the external surface of the glass microspheres; or
wherein the hollow glass microspheres are treated in a solution having a pH greater than 10 prior to mixing with the Pristine Graphene Particles to provide a negative charge on the external surface of the glass microspheres; or wherein the hollow glass microspheres are treated in a solution having a pH greater than 11 prior to mixing with the Pristine Graphene Particles to provide a negative charge on the external surface of the glass microspheres; or wherein the hollow glass microspheres are treated in a solution having a pH greater than 12 prior to mixing with the Pristine Graphene Particles to provide a negative charge on the external surface of the glass microspheres.

6. The method of claim 5, wherein the hollow glass microspheres are treated in a solution comprising a base selected from the group consisting of KOH, NaOH, NH₄OH, and combinations thereof.

7. The method of claim 1, wherein the Pristine Graphene Particles used in preparation of the graphene coated hollow glass microspheres have an average particle size of from about 35 nm to about 250 nm; or wherein the Pristine Graphene Particles used in preparation of the graphene coated hollow glass microspheres have an average particle size of from about 50 nm to about 200 nm; or wherein the Pristine Graphene Particles used in preparation of the graphene coated hollow glass microspheres have an average particle size of from about 75 nm to about 150.

8. The method of claim 1, wherein the Pristine Graphene Particles have a carbon content of at least about 99.4%, an oxygen content of less than 0.1% and comprise less than 0.5% of non-carbon or non-oxygen foreign substances and impurities.

9. The method of claim 1, wherein the Pristine Graphene Particles are treated with a surfactant.

10. The method of claim 9, wherein the Pristine Graphene Particles are treated with a surfactant prior to mixing of the Pristine Graphene Particles with the hollow glass microspheres.

11. The method of claim 10, wherein the Pristine Graphene Particles are treated with a surfactant at the time of mixing of the Pristine Graphene Particles with the hollow glass microspheres.

12. The method of claim 1, wherein the surfactant is selected from the group consisting of sodium cholate and hexadecyltrimethylammonium bromide.

13. The method of claim 1, wherein the graphene coated hollow glass microspheres have an average graphene coating coverage of at least about 60% of the external surface area of the hollow glass microspheres when evaluated by FESEM at 250× magnification.

14. The method of claim 1, wherein the Pristine Graphene Particles are mixed with the hollow glass microspheres under gentle stirring conditions such that less than 30% of the hollow glass microspheres are broken during the preparation of the graphene coated hollow glass microspheres; or wherein the Pristine Graphene Particles are mixed with the hollow glass microspheres under gentle stirring conditions such that less than 20% of the hollow glass microspheres are broken during the preparation of the graphene coated hollow glass microspheres; or wherein the Pristine Graphene Particles are mixed with the hollow glass microspheres under gentle stirring conditions such that less than 10% of the hollow glass microspheres are broken during the preparation of the graphene coated hollow glass microspheres.

15. The method of claim 1, wherein the Pristine Graphene Particles are present on the hollow glass microspheres in an amount effective to provide graphene coated hollow glass microspheres having an L*a*b*color value of L*=about 15 to 17; a*=about −1 to 0; and b*=about −0.5 to −1.5; or wherein the Pristine Graphene Particles are present on the hollow glass microspheres in an amount effective to provide graphene coated hollow glass microspheres having an L*a*b*color value of about L*=16.6; a*=−0.43 & b*=−0.98.

16. The method of claim 1, wherein the Pristine Graphene Particles are present on the hollow glass microspheres in an amount effective to provide graphene coated hollow glass microspheres having an electrical conductivity of from about 0.4 S/m to about 0.6 S/m.

17. Graphene coated hollow glass microspheres prepared by the method of claim 1.

18. Graphene coated hollow glass microspheres comprising hollow glass microspheres having an average diameter of from about 10 μm to about 150 μm and a wall thickness of from about 0.5 μm to about 2 μm and having an external surface, wherein the external surface comprises a graphene coating formed from Pristine Graphene Particles associated on the external surface of the hollow glass microspheres by ionic interaction.
